(19) United States
(12) Patent Application Publication
(10) Pub. No.: US 2005/0216532 A1
(43) Pub. Date: Sep. 29, 2005

(54) System and method for file migration

(76) Inventor: John C. Lallier, Massapequa Park, NY (US)

Correspondence Address: KAYE SCHOLER LLP, 425 PARK AVENUE, NEW YORK, NY, 10022-3598, US

(21) Appl. No.: 10/808,185

(22) Filed: Mar. 24, 2004

(51) Int. Cl. G06F 12/00

(52) U.S. Cl. 707/204

(57) ABSTRACT

A system and method are provided for migrating data files from a source file volume to a target file volume, wherein a target file volume is generated on a target storage device, and a target directory is created based on a directory in the source file volume. In addition, for each file stored in the source file volume, a corresponding stub file is created in the target file volume. The target file volume is mounted to enable a host to access data stored in the target file volume. Files are then copied from the source file volume to the target file volume. In one embodiment, a data processing request is received from the host specifying a stub file stored in the target file volume, a file in the source file volume is identified that corresponds to the specified stub file, and the file is copied from the source file volume to the target file volume. Requested data is retrieved from the copied file and provided to the host.

### BACKGROUND OF THE INVENTION

1. Field of the Invention

The invention relates generally to a system and method for storing data, and more particularly, to a system and method for migrating data from a source storage system to a target storage system.

2. Description of the Related Art

In many computing environments, large amounts of data are written to and retrieved from storage devices connected to one or more computers. Due to this ever-increasing quantity of data, the need to manage data storage in an efficient manner has become a primary need in many industries.

One common task often required in managing a data storage operation is the moving or “migration” of data from one storage system to another. The need to migrate data may arise for any one of a variety of reasons, such as, for example, the need to move data from an older storage system to a newer storage system, or to free up a particular storage system for repairs or maintenance. When a data migration operation is performed, the storage system that originally contains the data is typically referred to as the “source,” while the storage system to which data is moved is referred to as the “target.”

Conventional techniques for migrating data typically require the source storage system to interrupt host access to data for a period of time while data is copied from the source storage system to the target storage system. Such an interruption can represent a serious inconvenience to users, as well as to the system operator. In some cases, an interruption of even a few minutes is unacceptable.

Prior art techniques have been developed to allow block-level storage devices to migrate data in a manner that is relatively transparent to the host. In accordance with one such technique, for example, the target device is coupled to a host and then to the source device, and the target device is allowed to receive and handle data processing requests. If a data processing request pertains to a data block that has already been copied from the source device to the target device, the requested data is retrieved from the target device and provided to the host. If the data processing request pertains to a data block that has not been copied to the target device, the data block is staged from the source device to the target device. In addition, data blocks are copied from the source device to the target device in a background data transfer operation. Each data block to be copied is identified in a copy map, which may be a bit map that identifies each data block remaining to be copied by a “flag.” As each data block is copied, the corresponding flag in the copy map is reset.

### SUMMARY OF THE INVENTION

Existing techniques fail to provide for migrating data stored on a file-level basis. Accordingly, there is a need for a system and method for migrating data stored on a file-level basis, from a first storage system to a second storage system, while allowing users to access the data with little or no interruption. Similarly, a need exists for a method and system for migrating data stored on a file-level basis, from a first storage system, comprising one or more storage devices distributed in a network, to a second storage system, comprising one or more storage devices distributed in a network, while allowing users to access the data with little or no interruption.

Accordingly, the invention provides a method and system for migrating one or more data files stored in a source file volume on a source storage device, to a target storage device. A target file volume is created on the target storage device. A target directory is created in the target volume, based on the directory in the source file volume. Additionally, for each file stored in the source file volume, a corresponding stub file is created in the target file volume. The target file volume is mounted to enable a host computer to access data stored in the target file volume. Finally, files are copied from the source file volume to the target file volume.

In one embodiment of the invention, a data processing request is received from a host, specifying a stub file stored in the target file volume. A file is identified in the source file volume that corresponds to the specified stub file, and the file is copied from the source file volume to the target file volume. Requested data is retrieved from the copied file and provided to the host.

In another embodiment of the invention, a data processing request is received from a host, specifying a stub file stored in the target file volume. A file is identified in the source file volume that corresponds to the specified stub file, and requested data is retrieved from the file and provided to the host.

In a further embodiment of the invention, a background file migration routine is performed. A file is selected in the target file volume, and a determination is made that the selected file is a stub file. A file is identified in the source file volume that corresponds to the selected file, and the identified file is copied from the source file volume to the target file volume.

### BRIEF DESCRIPTION OF THE DRAWINGS

These and other features and advantages of the invention will be apparent to those skilled in the art from the following detailed description of preferred embodiments, taken together with the accompanying drawings, in which:

FIG. 1 illustrates a system that is used to store data files, in accordance with an embodiment of the invention;

FIG. 2 illustrates schematically a source volume maintained by the system of FIG. 1, in accordance with an embodiment of the invention;

FIG. 3 illustrates a system that is used to migrate data files, in accordance with an embodiment of the invention;

FIG. 4 illustrates a target manager used by the system illustrated in FIG. 3;

FIG. 5 illustrates a table maintained by a target manager to organize and store data files, in accordance with an embodiment of the invention;

FIG. 6 is a flowchart depicting a routine for generating a target volume, in accordance with an aspect of the invention;

FIG. 7 illustrates a target volume that is accessed by a host, and a source volume, in accordance with an aspect of the invention;

FIG. 8 is a flowchart depicting a routine for responding to read commands received from a host, in accordance with an embodiment of the invention;

FIG. 9 is a flowchart depicting a routine for responding to read commands received from a host, in accordance with another embodiment of the invention;

FIG. 10 is a flowchart depicting a routine for processing read-write commands received from a host, in accordance with an embodiment of the invention;

FIG. 11 is a flowchart depicting a routine for processing write-only commands received from a host, in accordance with an embodiment of the invention; and

FIG. 12 is a flowchart depicting a routine for de-migrating files from a source volume to a target volume, in accordance with an aspect of the invention.

### DETAILED DESCRIPTION OF THE PREFERRED EMBODIMENTS

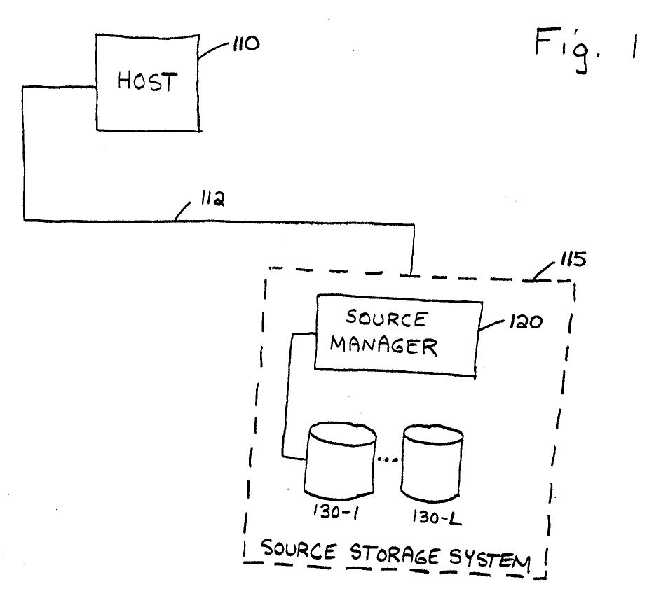

FIG. 1 illustrates a system that is used to store data files, in accordance with an embodiment of the invention. In this illustrative embodiment, host 110 may be any device capable of generating data processing commands such as commands to read data from or write data to a specified file. In one embodiment, host 110 is a computer. In another embodiment, host 110 may be, for example, a software application. Host 110 transmits data processing commands to, and receives data from, source storage system 115. For example, host 110 may transmit data to source storage system 115 accompanied by a command to store the data in a specified file. In response, source storage system 115 identifies the location of the file and stores the data.

Host 110 communicates with source storage system 115 via network 112. Network 112 may be implemented as one or more of a number of different types of networks, such as, for example, an intranet, a local area network (LAN), a wide area network (WAN), an internet, Fibre Channel-based storage area network (SAN) or Ethernet. Alternatively, network 112 may be implemented as a combination of different types of networks.

In the embodiment shown in FIG. 1, source storage system 115 comprises source manager 120, which is connected to one or more storage devices 130-1 through 130-L, where L is an integer. Source manager 120 manages the storage of data files on, and the retrieval of data files from, storage devices 130. Storage devices 130 may be, for example, disk drives. Hereinafter, the terms “storage device” and “disk drive” are used interchangeably. However, it should be noted that in alternative embodiments, storage devices 130 may be any devices capable of storing data files, including, without limitation, magnetic tape drives, optical disks, etc.

In this embodiment, source manager 120 may be any device or software application that manages data storage tasks on a file-level basis. Accordingly, source manager 120 organizes data in “logical units” (e.g., files) and allows other devices (e.g., other devices connected to network 112) to access data by identifying a logical unit containing the data rather than the physical storage location of the data. Because data stored on source storage system 115 may be retrieved by providing to source manager 120 an identifier of a respective logical unit, rather than a physical location, data managed by source manager 120 may be accessible to a large number of devices on network 112. Source manager 120 permits, for example, cross-platform file sharing in network 112. In one embodiment, source manager 120 is a NAS filer. In another embodiment, source manager 120 is a file server.

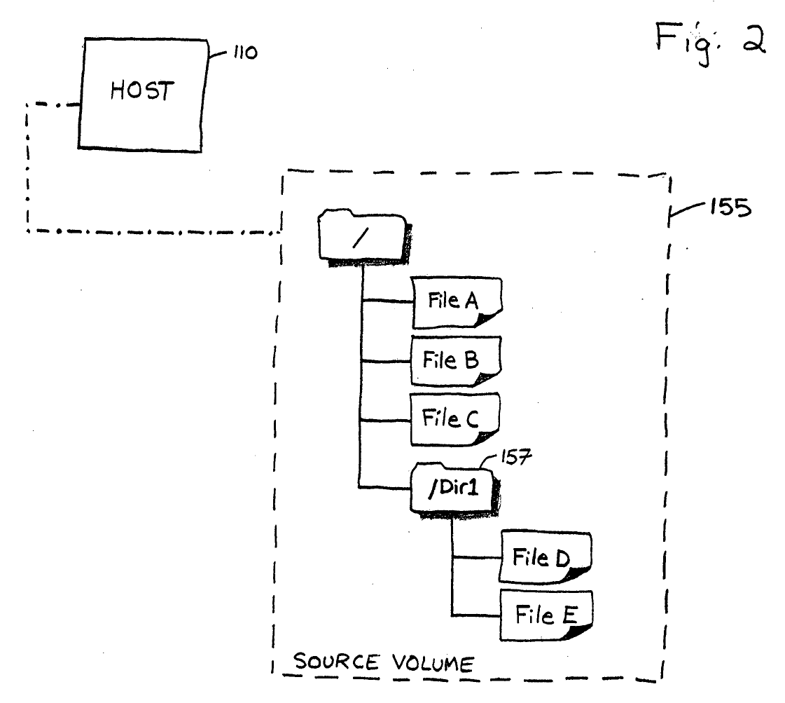

Logical units are often organized into larger groups referred to as “logical volumes,” or, alternatively, “file volumes,” comprising multiple data files organized in one or more directories. As an illustrative example, FIG. 2 illustrates schematically a file volume that may be maintained on source storage system 115. Referring to FIG. 2, source volume 155 comprises multiple files, e.g., files A, B, C, etc., organized in various directories. As an example, subdirectory 157, indicated by “/Dir1”, contains File D and File E. It should be noted at this point that the various data files stored in a file volume (e.g., Files A, B, C, etc.) may be stored collectively on a single storage device, e.g., disk drive 130-1, or alternatively may be stored collectively on multiple storage devices, e.g., File A on disk drive 130-1, File B on disk drive 130-2, etc.

One advantage associated with file-level storage systems is their ability to enable a host to access data without having knowledge of the physical address of the data. Instead, a host may access data by identifying a file that contains the data. In the case of a read command, for example, the host may submit a read command specifying a file containing the requested data, and, in response, the storage system identifies the physical location of the file, accesses the file and provides the requested data to the host. Accordingly, FIG. 2 may be viewed as a schematic representation of the data stored in source volume 155 as it appears to host 110. Based on this file-level representation of data, host 110 may transmit to source storage system 115 a command to read, say, File A, without knowing the location of File A, or a command to write data to, say, File D without knowing the location of File D. In the embodiment illustrated in FIG. 1, such data processing commands are received and processed by source manager 120 in a manner that is transparent to host 110.

To manage data, source manager 120 may employ any network-based file system. For example, in accordance with one embodiment, source manager 120 may employ the well-known Common Internet File System (CIFS) to enable file sharing over network 112. CIFS defines a standard remote file-system-access protocol for use over the Internet, enabling groups of users to work together, and to share documents across the Internet or within corporate intranets. Among other features, CIFS provides a mechanism for determining the degree to which a host is allowed to access a desired file stored on a remote storage system, based on various factors including the number of other host devices that currently request access to the desired file. In alternative embodiments, source manager 120 may utilize other file sharing protocols, e.g., Network File System (NFS), Apple File System, etc.

A system and method are provided for de-migrating file-level data from a source volume to a target volume while permitting a host to continue to access the data with little or no disruption. In accordance with one aspect of the invention, a target storage system is installed and connected to network 112. Host 110 begins submitting data processing commands to the target storage system, and ceases communicating with source storage system 115.

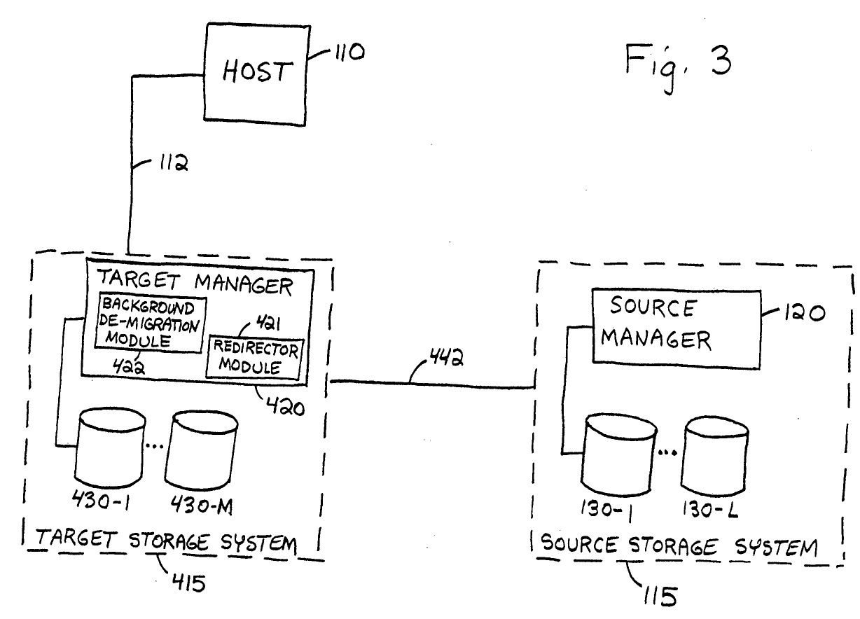

FIG. 3 illustrates a system that may be utilized to carry out this aspect of the invention. In the embodiment illustrated in FIG. 3, target storage system 415 communicates with host 110 via network 112. Target storage system 415 also communicates with source storage system 115, via path 442, which in one embodiment may be a communication link over network 112. In this embodiment, host 110 does not communicate directly with source storage system 115. Target storage system 415 comprises target manager 420 and storage devices 430-1 through 430-M, where M is an integer.

Target manager 420 manages the storage of data files on, and the retrieval of data from, storage devices 430. Target manager 420 may be any device or software application capable of managing data storage at a file level. In one embodiment, target manager 420 is a NAS filer. In another embodiment, target manager 420 is a file server.

Storage devices 430 may be, for example, disk drives. In alternative embodiments, storage devices 430 may be any devices capable of storing data files, including, without limitation, magnetic tape drives, optical disks, etc. Storage devices 430 are connected to target manager 420, in accordance with one embodiment, by Fibre Channel interfaces, SCSI connections, or a combination thereof.

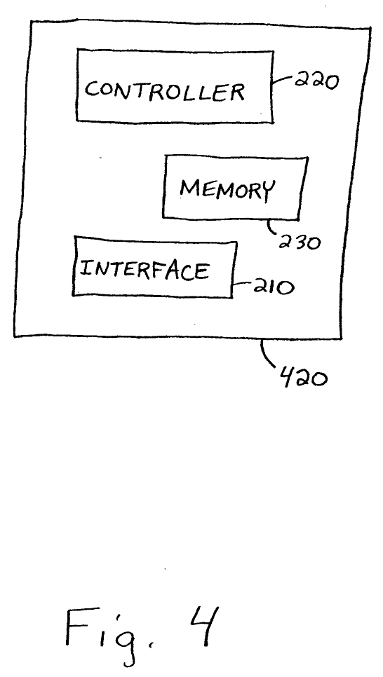

FIG. 4 illustrates components of target manager 420, in accordance with one embodiment of the invention. Target manager 420 comprises controller 220, memory 230, and interface 210. Controller 220 orchestrates the operations of target manager 420, including the handling of data processing commands received from network 112, and sending I/O commands to storage devices 430. In one embodiment, controller 220 is implemented by a software application. In an alternative embodiment, controller 220 is implemented by a combination of software and digital or analog circuitry.

In one embodiment, communications between controller 220 and network 112 are conducted in accordance with IP or Fibre Channel protocols. Accordingly, controller 220 receives from network 112 data processing requests formatted according to IP or Fibre Channel protocols.

In one embodiment, memory 230 is used by controller 220 to manage the flow of data files to and from, and the location of data on, storage devices 430. For example, controller 220 may store various tables indicating the locations of various data files stored on storage devices 430.

In one embodiment, interface 210 provides a communication gateway through which data may be transmitted between target manager 420 and network 112. Interface 210 may be implemented using a number of different mechanisms, such as one or more SCSI cards, enterprise systems connection cards, fiber channel interfaces, modems, network interfaces, or a network hub.

In accordance with the invention, target manager 420 stores data files on a file-level basis. In one embodiment, target manager 420 may dynamically allocate disk space according to a technique that assigns disk space to one or more “virtual” file volumes as needed. Accordingly, logical units (e.g., files) that are managed by target manager 420 are organized into “virtual” volumes. The virtual file volume system allows an algorithm to manage a virtual file volume having assigned to it an amount of virtual storage that is larger than the amount of physical storage available on a single disk drive. Accordingly, large virtual file volumes can exist on a system without requiring an initial investment of an entire storage subsystem. Additional physical storage may then be assigned as it is required without committing these resources prematurely. Alternatively, a virtual file volume may have assigned to it an amount of virtual storage that is smaller than the amount of available physical storage.

In accordance with the virtual file volume system, target manager 420 may, for example, generate a virtual file volume VOL1 having a virtual size X, where X represents an amount of virtual storage space assigned to volume VOL1. In this example, target manager 420 may inform host 110 that virtual file volume VOL1, of size X, has been generated. However, target manager 420 initially assigns to volume VOL1 an amount of physical storage space equal to Y, where Y is typically smaller than X. As files are added to volume VOL1, target manager 420 may assign additional physical storage space to accommodate the added files. In this example, files associated with a file volume VOL1 may be located on a single disk drive or on multiple disk drives. Host 110, however, has no information concerning the location of various files within volume VOL1; instead, volume VOL1 appears to host 110 as a single unified file volume.

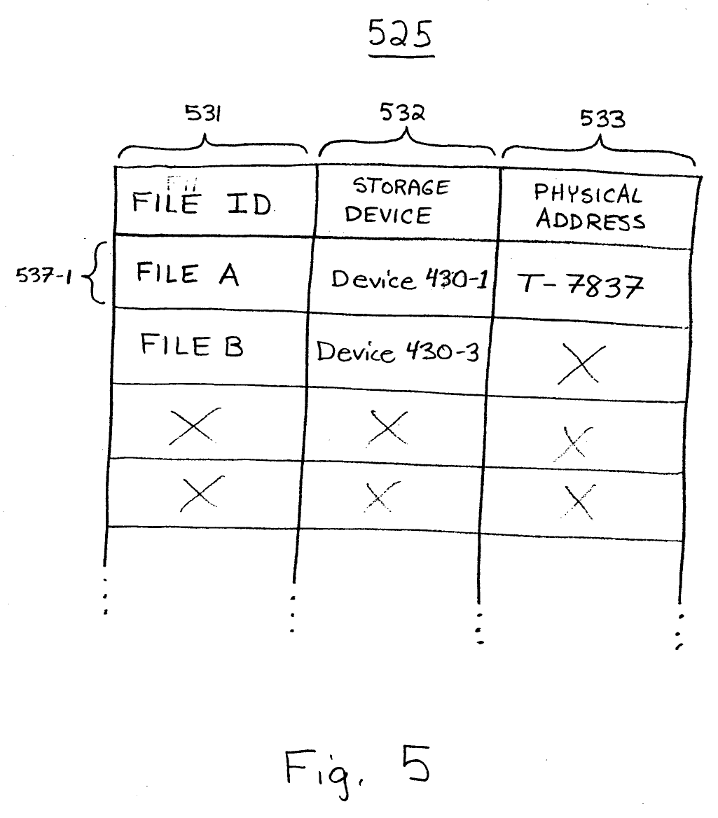

To organize the data files stored in a virtual file volume, target manager 420 may maintain a table such as that shown in FIG. 5. Table 525 contains data pertaining to various files that are assigned to a respective volume, e.g., VOL1. Table 525 contains three columns 531-533. Column 531 includes data identifying a file, e.g., File A. Column 532 includes data identifying, for each respective file, a storage device on which the file is stored. Column 533 includes data specifying the physical address of the respective file on the storage device. Referring to row 537-1, for example, file A is stored on storage device 430-1 at location T-7837.

In accordance with a second aspect of the invention, a target file volume containing an “image” of source volume 155 is generated on target storage system 415. The target file volume includes a “shadow directory” that mirrors the directory structure of source volume 155, and additionally includes one or more files corresponding to the files present in source volume 155.

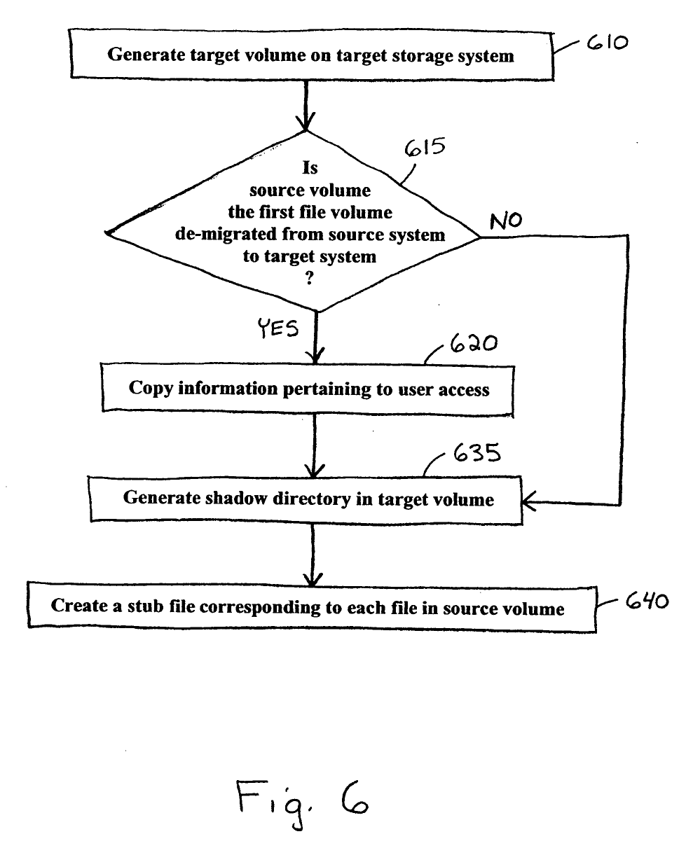

FIG. 6 is a flowchart depicting a routine for generating a target file volume in accordance with this aspect of the invention. The routine outlined in FIG. 6 is also discussed with reference to FIGS. 1 and 2. Specifically, in this illustrative example, a target file volume is generated on target storage system 415 based on information present in source volume 155.

At step 610, controller 220 of target manager 420 generates, on target storage system 415, a target file volume (referred to as the “target volume”) of a size equal to or larger than that of source volume 155. If controller 220 is unable to determine the size of source volume 155, the user may be prompted for this information.

As indicated by block 615, if source volume 155 is not the first file volume de-migrated from source storage system 115 to target storage system 415, then the routine proceeds directly to step 635. However, if source volume 155 is the first file volume to be de-migrated from source storage system 115 to target storage system 415, then at step 620 controller 220 of target manager 420 copies from source storage system 115 (if the CIFS file-sharing protocol is used) user-access information including, for example, user names, account restriction information, home directory information, group membership information, etc. In an alternative embodiment (in which the NFS protocol is employed), controller 220 may, at step 620, copy system information including specific IP addresses, user names, quotas, etc.

At step 635, controller 220 generates within the target volume a “shadow directory” having the same structure as the directory within source volume 155. At step 640, controller 220 creates, for each file stored in source volume 155, a corresponding “stub” file within the target volume. Each stub file appears to host 110 to be the corresponding file stored in source volume 155; however, rather than containing a copy of the data stored in the corresponding file, a stub file contains an indicator that points to the corresponding file on source storage system 115. In one embodiment, a stub file may hold an indicator that simply identifies the corresponding file on source storage system 115. In an alternative embodiment, a stub file may contain an indicator that points to the physical location of the corresponding file.

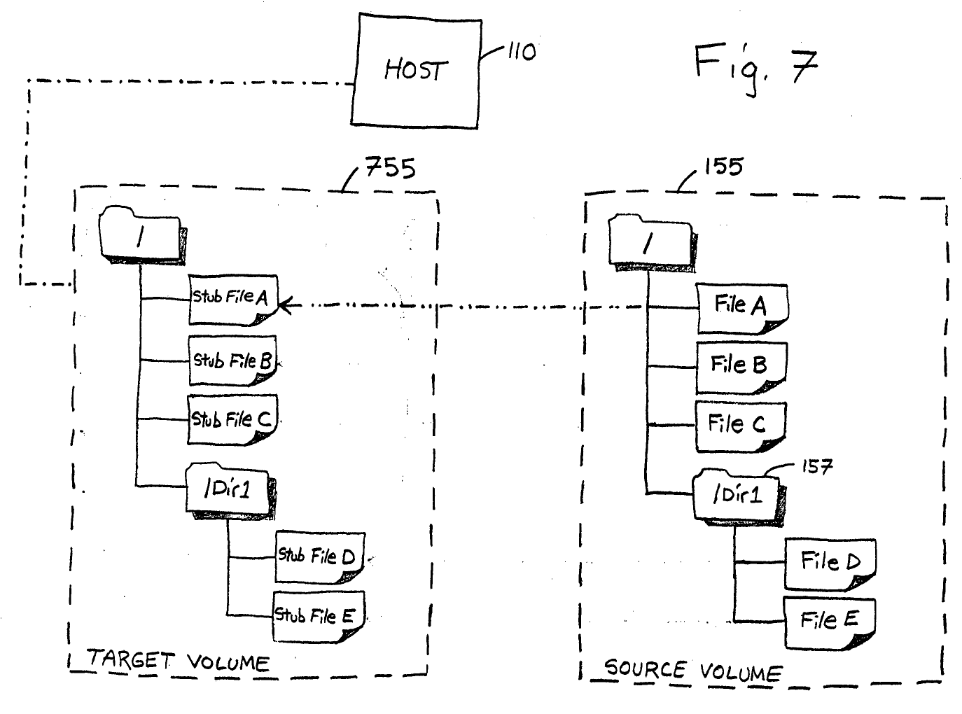

FIG. 7 illustrates schematically a target volume 755 as it may appear to host 110, and source volume 155, in accordance with this aspect of the invention. In this example, target volume 755 is a file volume created on target storage system 415, having a size equal to that of source volume 155. Referring to FIG. 7, target volume 755 comprises a shadow directory that duplicates the directory structure of source volume 155. Additionally, target volume 755 comprises a stub file for each file in source volume 155. By way of example, stub file A corresponds to File A, and contains an indicator that points to File A in source volume 155.

In accordance with a third aspect of the invention, target volume 755 is “mounted,” such that host 110 is provided access to the directories and files within target volume 755. After mounting, data processing commands submitted by host 110 to source storage system 115 are processed by target storage system 415. In accordance with one embodiment, target volume 755 is mounted without host 110 being informed that it no longer has direct access to data files on source volume 155. In this embodiment, host 110 continues to direct its data processing commands concerning source volume 155 to source storage system 115; however,.those data processing commands are retransmitted to target storage system 415 and processed by target manager 420. In this embodiment, the directories within target volume 755 appear to host 110 to be those in source volume 155, and the stub files in target volume 755 appear to host to be the corresponding files in source volume 155. For example, referring to FIG. 7, after mounting, stub file A appears to host 110 to be File A.

In one embodiment, a redirector module, which operates in a well-known manner, mounts target volume 755. The redirector module receives and processes data processing commands from host 110, and redirects the requests to source storage system 115 as necessary to obtain requested data files. In the embodiment illustrated in FIG. 3, redirector module 421 resides in target manager 420. In this embodiment, redirector module 421 may be, for example, a software application. In an alternative embodiment, redirector module 421 may be implemented by circuitry or by a combination of software and circuitry.

In accordance with a fourth aspect of the invention, redirector module 421 de-migrates files from source volume 155 to target volume 755 in response to read commands received from host 110. In one embodiment, in which redirector module 421 operates in a “recall” mode, if a read command specifying a requested file is received from host 110, the specified file is de-migrated automatically in response to the read command. In accordance with this embodiment, after the specified file is de-migrated to target volume 755, redirector module 421 provides the requested data to host 110.

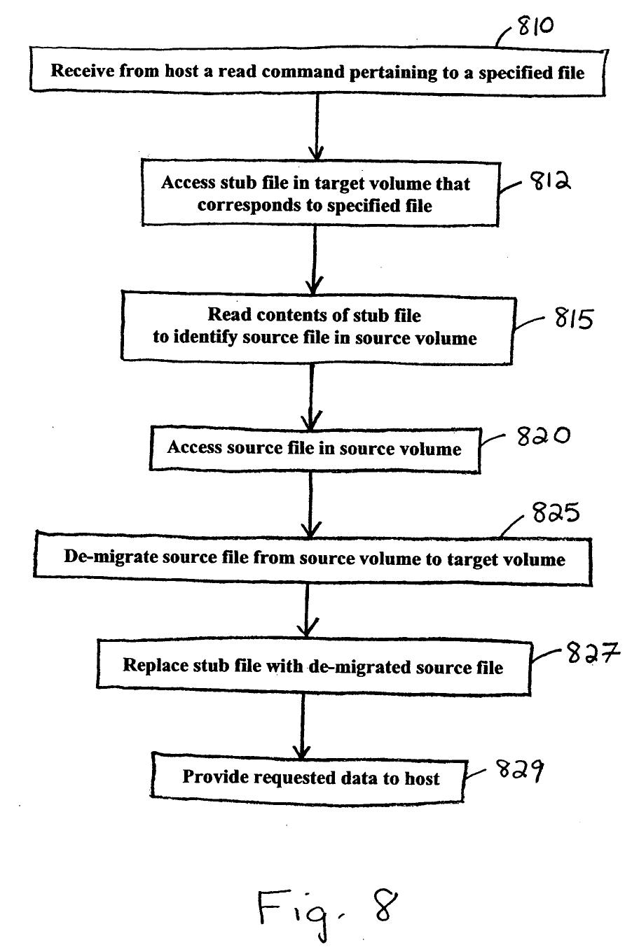

FIG. 8 is a flowchart depicting a routine for responding to read commands received from host 110, in accordance with this embodiment of the invention. At step 810, redirector module 421 receives a read command from host 110. By way of example (and referring to FIG. 7), the read command may contain a request for data from, say, File A. At step 812, redirector module 421 accesses the stub file in target volume 755 that corresponds to the specified file—in this example, stub file A. At step 815, redirector module 421 reads the contents of the stub file to identify the associated source file in source volume 155. In this example, stub file A may contain an indicator that points to File A in source volume 155. At step 820, redirector module 421 accesses the source file (e.g., file A) in source volume 155, and (at step 825) de-migrates the source file from source volume 155 to target volume 755. In one embodiment, redirector module 421 performs the de-migration by copying the source file to target volume 755. At step 827, redirector module 421 replaces the stub file with the de-migrated source file. At step 829, redirector module 421 retrieves the requested data from the de-migrated file and provides the requested data to host 110.

In an alternative embodiment, in which redirector module 421 operates in a “pass-through” mode, a read command does not automatically cause de-migration of the specified file. In this embodiment, if the size of the source file exceeds a predetermined limit, redirector module 421 reads the requested data from the source file and transmits the data to host 110 without de-migrating the source file to target volume 755. In such case, the source file is de-migrated at a later stage during a background de-migration routine (discussed below). If the source file's size does not exceed the predetermined limit, redirector module 421 de-migrates the source file to target volume 155, and provides the requested data to host 110.

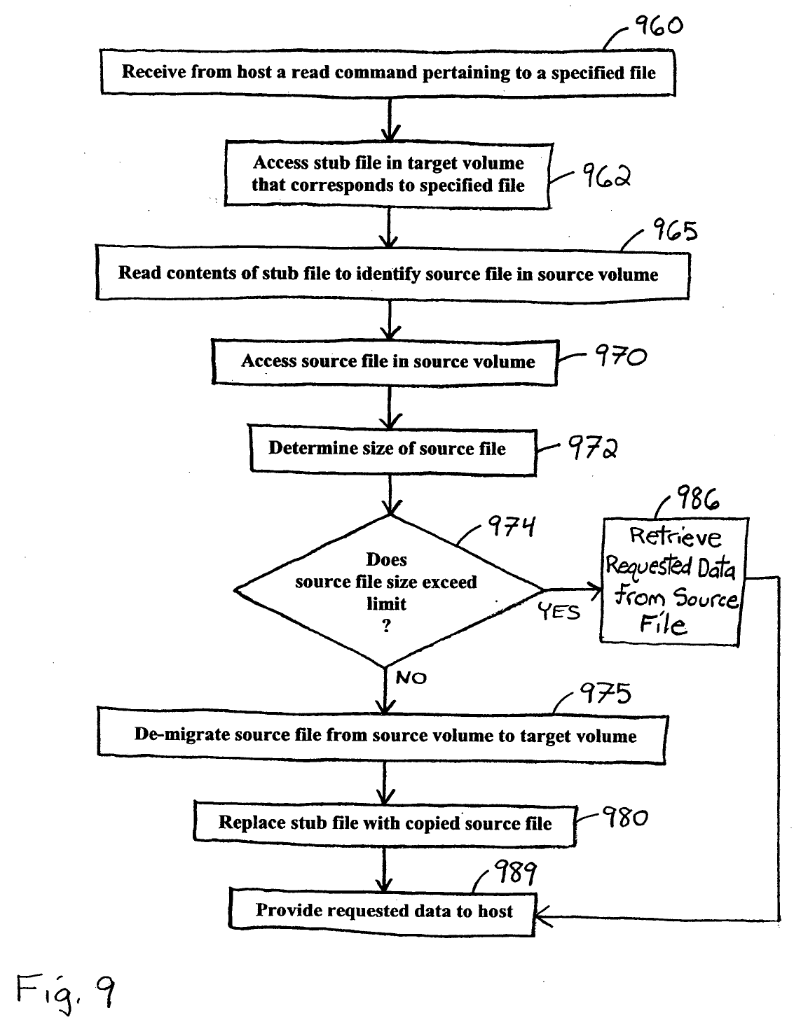

FIG. 9 is a flowchart depicting a routine for responding to read commands received from host 110, in accordance with this alternative embodiment. At step 960, redirector module 421 receives a read command from host 110. By way of example, the read command in this instance may contain a request for data from, say, File B. At step 962, redirector module 421 accesses the stub file in target volume 755 that corresponds to the specified file—in this example, stub file B. At step 965, redirector module 421 reads the contents of the stub file to identify the associated source file in source volume 155. In this example, stub file B may contain an indicator pointing to File B in source volume 155. At step 970, redirector module 421 accesses the specified file (in this instance, file B) in source volume 155. At step 972, redirector module 421 determines the size of the source file. Referring to block 974, if the size of the source file exceeds a predetermined limit (such as, for example sixty-four (64) megabytes), redirector module 421, at step 986, retrieves the-requested data from the source file and proceeds to step-989 without de-migrating the source file. In this case, at step 989, redirector module 421 provides the requested data to host 110.

If the size of the source file does not exceed the predetermined limit, then at step 975 redirector module 421 de-migrates the source file from source volume 155 to target volume 755. At step 980, redirector module 421 replaces the stub file with the de-migrated source file. At step 989, redirector module 421 retrieves the requested data from the de-migrated file and provides the requested data to host 110.

In accordance with a fifth aspect of the invention, redirector module 421 de-migrates files from source volume 155 to target volume 755 in response to a write command received from host 110. In one embodiment, redirector module 421 receives a read-write command concerning a file on source volume 155, de-migrates the specified file and performs the read-write operation.

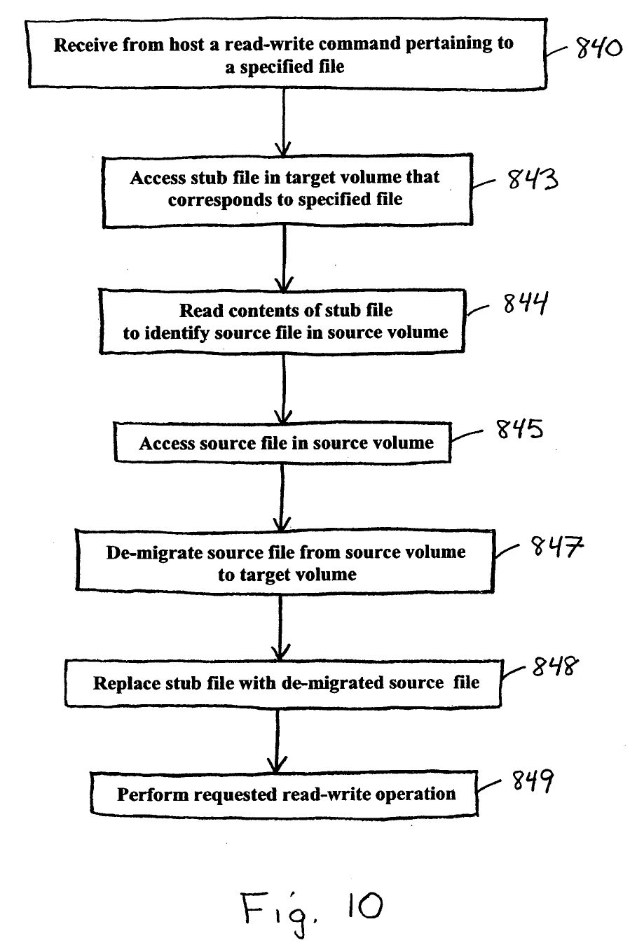

FIG. 10 is a flowchart depicting a routine for processing read-write commands received from host 110, in accordance with this embodiment. At step 840, redirector module 421 receives from host 110 a read-write command pertaining to a specified file. At step 843, redirector module 421 accesses the stub file in target volume 155 that corresponds to the specified file. At step 844, redirector module 421 reads the contents of the stub file to identify the associated source file in source volume 155. At step 845, redirector module 421 accesses the source file in source volume 155. At step 847, redirector module 421 de-migrates the source file from source volume 155, and at step 848, replaces the stub file with the de-migrated source file. At step 849, redirector module 421 performs the requested read-write operation.

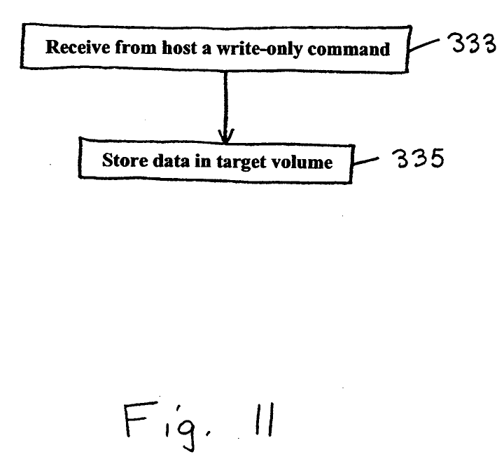

In an alternative embodiment, redirector module 421 receives a write-only command from host 110 and writes the data to target volume 755. FIG. 11 is a flowchart depicting a routine for processing write-only commands received from host 110, in accordance with this embodiment. At step 333, redirector module 421 receives a write-only command requesting that specified data be written into a new file, or, alternatively, that specified data be stored by overwriting an existing file. At step 335, redirector module 421 stores the data in target volume 755. In this embodiment, step 335 may be performed by creating a new file in target volume 755, or by overwriting an existing file in target volume 755, as appropriate.

In accordance with a sixth aspect of the invention, a background de-migration routine copies files from source volume 155 to target volume 755 when system resources allow. In one embodiment, the background de-migration routine may be performed by a background de-migration module. Referring to FIG. 3, background de-migration module 422 may reside in target manager 420. In this embodiment, background de-migration module 422 may be a software application. In another embodiment, background de-migration module 422 may be implemented by circuitry or by a combination of software and circuitry. Further in accordance with this embodiment, background de-migration module 422 operates only when resources are available, e.g., when neither controller 220 nor redirector module 421 is busy handling data processing commands or performing other tasks.

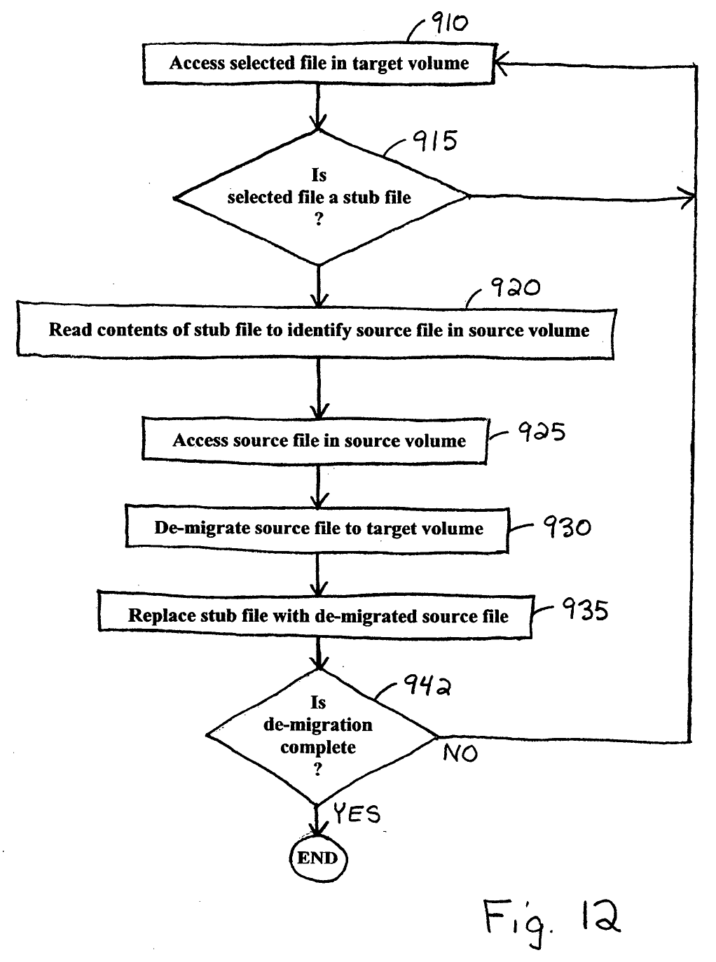

In one embodiment, background de-migration module 422 may examine, consecutively, each file listed in the directory of target volume 755 and perform de-migration where necessary. FIG. 12 is a flowchart depicting a routine for de-migrating files from source volume 155 to target volume 755, in accordance with this embodiment of the invention. At step 910, background de-migration module 421 selects a file listed in the shadow directory of target volume 755, and accesses the selected file in target volume 755, to determine its status. Referring to block 915, if the file is a complete, de-migrated file, background de-migration module 422 proceeds to select another file listed in the shadow directory, and the routine recommences at step 910. If background de-migration module 422 finds that the selected file is a stub file, then, at step 920, the contents of the stub file are examined to identify the associated source file in source volume 155. At step 925, background de-migration module 422 accesses the source file in source volume 155, and at step 930, de-migrates the source file to target volume 755. At step 935, background de-migration module 422 replaces the stub file with the de-migrated source file. Referring to block 942, if at this point the de-migration is complete (i.e., all files in source volume 155 are de-migrated), the routine comes to an end. Otherwise, redirector module 421 selects another file listed in the shadow directory, and the routine recommences at step 910.

The foregoing merely illustrates the principles of the invention. It will thus be appreciated that those skilled in the art will be able to devise numerous other arrangements which embody the principles of the invention and are thus within its spirit and scope.

For example, the systems of FIGS. I and 3 are disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

1. A method for migrating one or more data files stored on a source storage device to a target storage device, comprising:
receiving from a host a data processing request specifying a data file;
examining a stub file stored on the target storage device that corresponds to the specified data file, wherein the stub file contains a pointer identifying a source data file stored on the source storage device that corresponds to the specified data file; and
copying the source data file from the source storage device to the target storage device.

2. The method of claim 1, further comprising:
retrieving requested data from the copied data file; and
providing the requested data to the host.

3. The method of claim 1, wherein the source data file is stored in a file volume on the source storage device.

4. The method of claim 1, wherein the stub file is stored in a file volume on the target storage device.

5. The method of claim 1, wherein the target storage device comprises a NAS filer.

6. The method of claim 1, wherein the target storage device comprises a file server.

7. The method of claim 1, wherein the data processing request is received from the host via a network.

8. The method of claim 1, wherein the pointer identifies a logical location of the source data file in the source file volume.

9. The method of claim 1, wherein the pointer identifies a physical location of the source data file on the source storage system.

10. The method of claim 1, further comprising replacing the stub file with the copied data file.

11. A method for migrating one or more data files stored on a source storage device to a target storage device, comprising:
receiving from a host a data processing request specifying a data file;
examining a stub file stored on the target storage device that corresponds to the specified data file, wherein the stub file contains a pointer identifying a source data file stored on the source storage device that corresponds to the specified data file;
determining a size of the source data file; and
copying the source data file from the source storage device to the target storage device, if the size of the source data file does not exceed a predetermined limit.

12. The method of claim 11, wherein the source data file is stored in a file volume on the source storage device.

13. The method of claim 11, wherein the stub file is stored in a file volume on the target storage device.

14. The method of claim 11, wherein the target storage device comprises a NAS filer.

15. The method of claim 11, wherein the target storage device comprises a file server.

16. The method of claim 11, wherein the data processing request is received from the host via a network.

17. The method of claim 11, wherein the pointer identifies a logical location of the source data file in the source file volume.

18. The method of claim 11, wherein the pointer identifies a physical location of the source data file on the source storage system.

19. A method for migrating one or more data files stored on a source storage device, to a target storage device, comprising:
receiving from a host a data processing request specifying a data file;
examining a stub file stored on the target storage device that corresponds to the specified data file, wherein the stub file contains a pointer identifying a source data file stored on the source storage device that corresponds to the specified data file;
retrieving requested data from the source data file; and
providing the requested data to the host.

20. The method of claim 19, wherein the source data file is stored in a file volume on the source storage device.

21. The method of claim 19, wherein the stub file is stored in a file volume on the target storage device.

22. The method of claim 19, wherein the target storage device comprises a NAS filer.

23. The method of claim 19, wherein the target storage device comprises a file server.

24. The method of claim 19, wherein the data processing request is received from the host via a network.

25. The method of claim 19, wherein the pointer identifies a logical location of the source data file on the source storage device.

26. The method of claim 19, wherein the pointer identifies a physical location of the source data file on the source storage system.

27. A method for migrating one or more data files stored on a source storage device, to a target storage device, comprising:
accessing a target file stored on the target storage device, wherein the target file is a stub file that contains a pointer identifying a source data file stored on the source storage device; and
copying the identified source data file to the target storage device.

28. The method of claim 27, wherein the source data file is stored in a file volume on the source storage device.

29. The method of claim 27, wherein the stub file is stored in a file volume on the target storage device.

30. The method of claim 27, wherein the target storage device comprises a NAS filer.

31. The method of claim 27, wherein the target storage device comprises a file server.

32. The method of claim 27, wherein the pointer identifies a logical location of the source data file on the source storage device.

33. The method of claim 27, wherein the pointer identifies a physical location of the source data file on the source storage system.

34. A system for migrating one or more data files stored on a source storage device to a target storage device, comprising:
an interface for receiving from a host a data processing request specifying a data file; and
a processor for examining a stub file stored on the target storage device that corresponds to the specified data file, wherein the stub file contains a pointer identifying a source data file stored on the source storage device that corresponds to the specified data file, and for copying the source data file from the source storage device to the target storage device.

35. The system of claim 34, wherein the processor additionally retrieves requested data from the copied data file, and provides the requested data to the host.

36. The system of claim 34, wherein the source data file is stored in a file volume on the source storage device.

37. The system of claim 34, wherein the stub file is stored in a file volume on the target storage device.

38. The system of claim 34, wherein the target storage device comprises a NAS filer.

39. The system of claim 34, wherein the target storage device comprises a file server.

40. The system of claim 34, wherein the data processing request is received from the host via a network.

41. The system of claim 34, wherein the pointer identifies a logical location of the source data file in the source file volume.

42. The system of claim 34, wherein the pointer identifies a physical location of the source data file on the source storage system.

43. The system of claim 34, further comprising replacing the stub file with the copied data file.

44. A system for migrating one or more data files stored on a source storage device to a target storage device, comprising:
an interface for receiving from a host a data processing request specifying a data file;
a processor for examining a stub file stored on the target storage device that corresponds to the specified data file, wherein the stub file contains a pointer identifying a source data file stored on the source storage device that corresponds to the specified data file;
wherein the processor determines a size of the source data file, and copies the source data file from the source storage device to the target storage device, if the size of the source data file does not exceed a predetermined limit.

45. The system of claim 44, wherein the source data file is stored in a file volume on the source storage device.

46. The system of claim 44, wherein the stub file is stored in a file volume on the target storage device.

47. The system of claim 44, wherein the target storage device comprises a NAS filer.

48. The system of claim 44, wherein the target storage device comprises a file server.

49. The system of claim 44, wherein the data processing request is received from the host via a network.

50. The system of claim 44, wherein the pointer identifies a logical location of the source data file in the source file volume.

51. The system of claim 44, wherein the pointer identifies a physical location of the source data file on the source storage system.

52. A system for migrating one or more data files stored on a source storage device, to a target storage device, comprising:
an interface for receiving from a host a data processing request specifying a data file; and
a processor for examining a stub file stored on the target storage device that corresponds to the specified data file, wherein the stub file contains a pointer identifying a source data file stored on the source storage device that corresponds to the specified data file, for retrieving requested data from the source data file, and for providing the requested data to the host.

53. The system of claim 52, wherein the source data file is stored in a file volume on the source storage device.

54. The system of claim 52, wherein the stub file is stored in a file volume on the target storage device.

55. The system of claim 52, wherein the target storage device comprises a NAS filer.

56. The system of claim 52, wherein the target storage device comprises a file server.

57. The system of claim 52, wherein the data processing request is received from the host via a network.

58. The system of claim 52, wherein the pointer identifies a logical location of the source data file on the source storage device.

59. The system of claim 52, wherein the pointer identifies a physical location of the source data file on the source storage system.

60. A system for migrating one or more data files stored on a source storage device, to a target storage device, comprising a processor for accessing a target file stored on the target storage device, wherein the target file is a stub file that contains a pointer identifying a source data file stored on the source storage device, and for copying the identified source data file to the target storage device.

61. The system of claim 60, wherein the source data file is stored in a file volume on the source-storage device.

62. The system of claim 60, wherein the stub file is stored in a file volume on the target storage device.

63. The system of claim 60, wherein the target storage device comprises a NAS filer.

64. The system of claim 60, wherein the target storage device comprises a file server.

65. The system of claim 60, wherein the pointer identifies a logical location of the source data file on the source storage device.

66. The system of claim 60, wherein the pointer identifies a physical location of the source data file on the source storage system.
